(19) United States
(12) Patent Application Publication
(10) Pub. No.: US 2015/0130572 A1
(43) Pub. Date: May 14, 2015

(54) SYSTEM FOR HOLDING INDIVUDALIZEZD IMPLEMENTS

(71) Applicant: Jessica Goirigolzarri, Plantation, FL (US)

(72) Inventor: Jessica Goirigolzarri, Plantation, FL (US)

(21) Appl. No.: 14/445,022

(22) Filed: Jul. 28, 2014

Related U.S. Application Data
(60) Provisional application No. 61/962,686, filed on Nov. 14, 2013.

(51) Int. Cl. H01F 7/02; A45F 5/00

(52) U.S. Cl. CPC H01F 7/0263; A45F 5/00
USPC 335/285

(57) ABSTRACT

The present invention is a system for carrying individualized articles, said system comprising: a main carrier having at least one magnetic material incorporated therewith; at least one expandable ring, having a central cavity and a relaxed configuration and an expanded configuration, whereby said expanded configuration is achieved by applying pressure to an expandable material incorporated with said expanded ring, said expanded ring further comprising at least one magnet constructed and arranged to interact with said magnet of said main body.

### INDEX TO RELATED APPLICATIONS

This application is a non-provisional of and claims benefit to U.S. Provisional Patent Application Ser. No. 61/962,686 filed Nov. 14, 2013 the disclosure of which is incorporated herein by reference in its entirety.

### BACKGROUND OF THE INVENTION

There are numerous devices and cases used to carry individualized implements. Many of these include pockets, slots, retainers and the like. However, there is a difficulty in that often, individual articles are not secured with these various holding devices and become lost. There is a need for a more effective system for carrying individualized articles.

### SUMMARY OF THE INVENTION

The present invention provides a case with a magnetic material incorporated therewith and at least one expandable ring for retaining and securing individualized articles. The expandable ring has at least one magnet associated therewith.

In one embodiment, the present invention is a system for carrying individualized articles, said system comprising: a main carrier having at least one magnetic material incorporated therewith;

at least one expandable ring, having a central cavity and a relaxed configuration and an expanded configuration, whereby said expanded configuration is achieved by applying pressure to an expandable material incorporated with said expanded ring, said expanded ring further comprising at least one magnet constructed and arranged to interact with said magnet of said main body.

The main carrier magnetic material is incorporated with either or both of a first main body rigid support or second main body rigid support. In one embodiment, the magnetic material is a separate component from the rigid support. In another embodiment, the rigid support is formed, at least partially of magnetic material.

In one embodiment, the main carrier is configured as a foldable case including, but not limited to a make up case, tool case, artist brush case, artist pen and/or pencil case, and the like.

In one embodiment, the expanded ring is configured for placement about the perimeter of an individualized article.

The individualized article includes but is not limited to, at least one of a makeup brush, pencil, pen, hand tool, stylus, artists tool, or combinations thereof.

In one embodiment, the main carrier carries at least one individualized article positioned within said ring central cavity and secured into position by said one magnet constructed and arranged to interact with said magnet of said main body.

### BRIEF DESCRIPTION OF THE SEVERAL VIEWS OF THE DRAWINGS

FIG. 1 is a perspective view of one embodiment of the present invention.

FIG. 2 is a perspective view in partial closed position of one embodiment of the present invention.

FIG. 3 is an exploded view of the components according to one embodiment of the present invention.

FIG. 4 is the side view of the expandable ring according to one embodiment of the present invention.

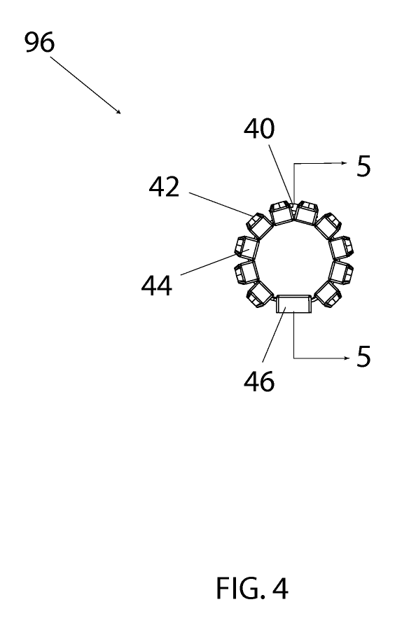

FIG. 5 is a bottom view of the expandable ring according to one embodiment of the present invention.

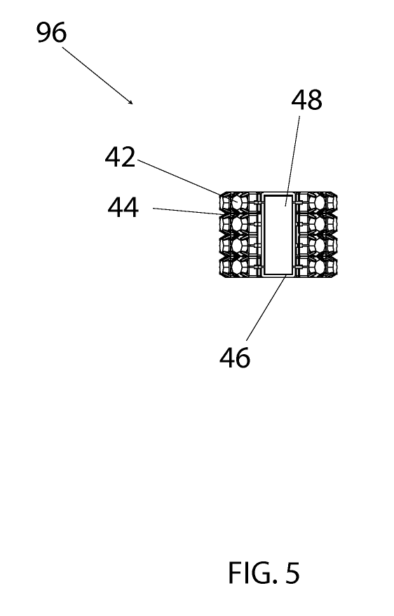

FIG. 6 is a bottom view demonstrating expansion of the expandable ring according to one embodiment of the present invention.

FIG. 7 is a top view of the expandable ring according to one embodiment of the present invention.

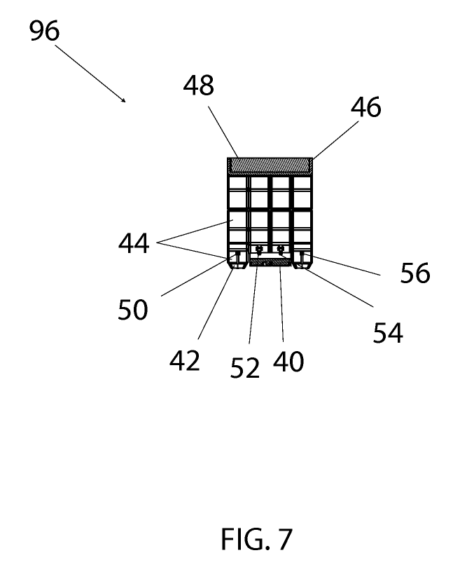

### DETAILED DESCRIPTION OF THE PREFERRED EMBODIMENT

The present invention, as generally understood, is a system for carrying individualized articles in a carry case. Main assembly 90 includes a First Main Body Flap 8, a Second Main Body Flap 10, and a Closing Flap 6. Incorporated onto Main Body Flap 8 is a First Cover 2, and incorporated onto Second Main Body Flap 10 is Second Cover 4. As generally understood, First Main Body Flap 8 has contained therein First Main Body Rigid Support 24. Second Main Body Flap 10 has contained therein Second Main Body Rigid Support 22. Any or both of First Main Body Rigid Support 24 or Second Main Body Rigid Support 22 are formed of or contain magnetic material selected to attract material utilized in magnet 46. Closing Flap 6 has contained therein Closing Flap Rigid Support 20. First Device Closing Portion 12 has contained therein First Device Closing Support 18. Second Device Closing Portion 14 has contained therein Rigid Support 16.

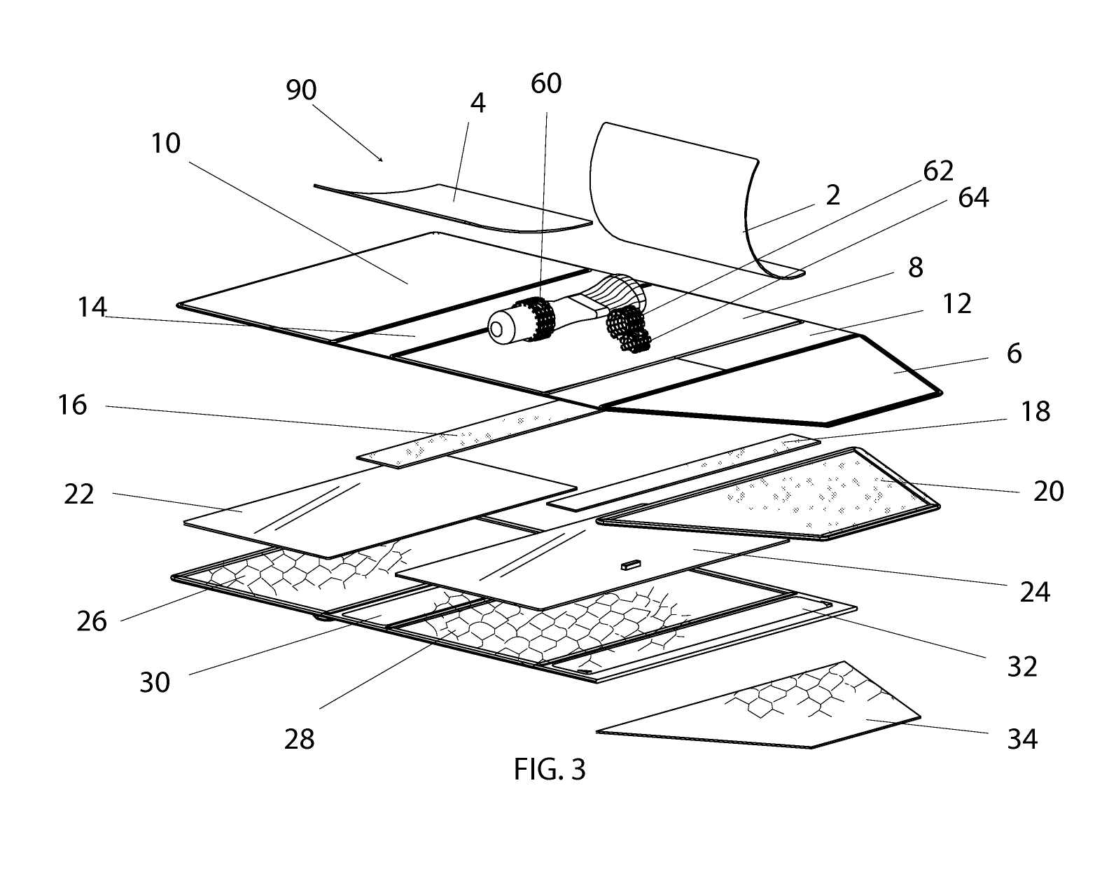

System 90 includes optionally a First Decorative Cover Region 28, a Second Decorative Cover Region 26, and Third Decorative Cover Region 34, respectively positioned as shown in FIG. 3. The system includes one or more Expandable Magnetic Rings 96. Ring System 96 has a plurality of settings 44, optionally having decorative stones or other decorative indicia 42, disposed outward from the center of Ring 96, and at least one Magnet 46 contained within Magnet Holder 48.

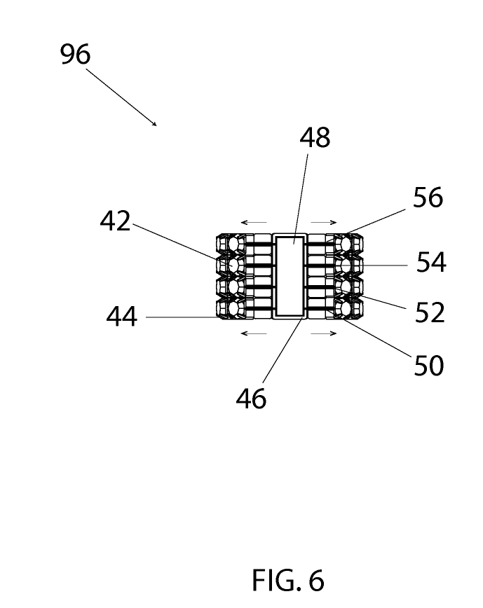

Each of settings 44 are connected with expandable bands. As demonstrated in FIG. 6, a First Expandable Band 50, a Second Expandable Band 52, a Third Expandable Band 54, and a Fourth Expandable Band 56 is utilized. Although the particular figure demonstrates an arrangement with four expandable bands, the present invention contemplates configuration as desired with at least one expandable band. Expandable bands not meaning to be limited and can include any type of rubber and/or elastic that will stretch when subject to pressure and return to a relaxed position when pressure is released.

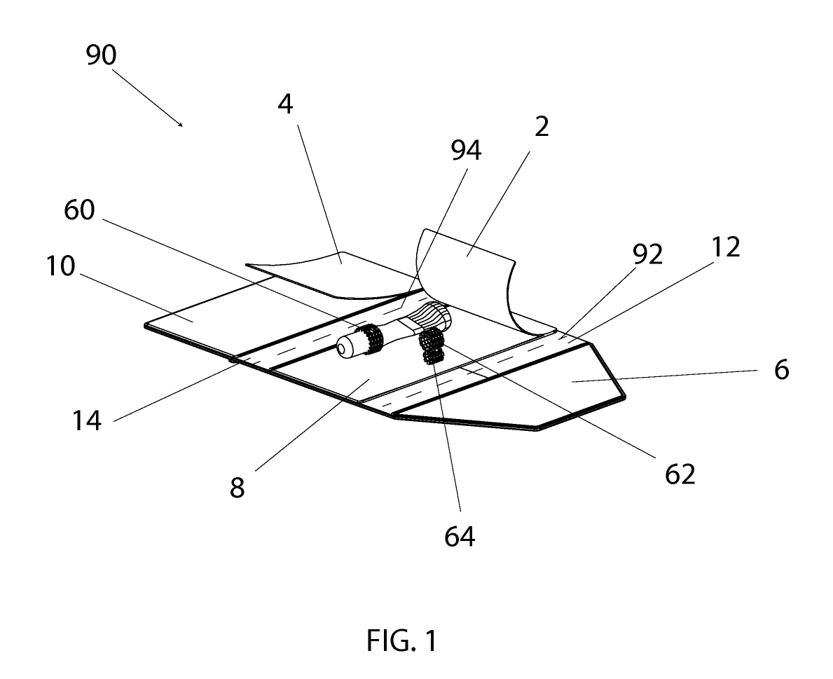

As demonstrated in FIG. 1, Ring 60 holds an individualized article, such as a makeup brush. Again, it is contemplated that the system of the present invention be configured and used in any environment where one or more individualized articles are held, carried, and stored. This can include, but would not be limited to, makeup brushes, artist brushes, pens, pencils, hand tools, and the like.

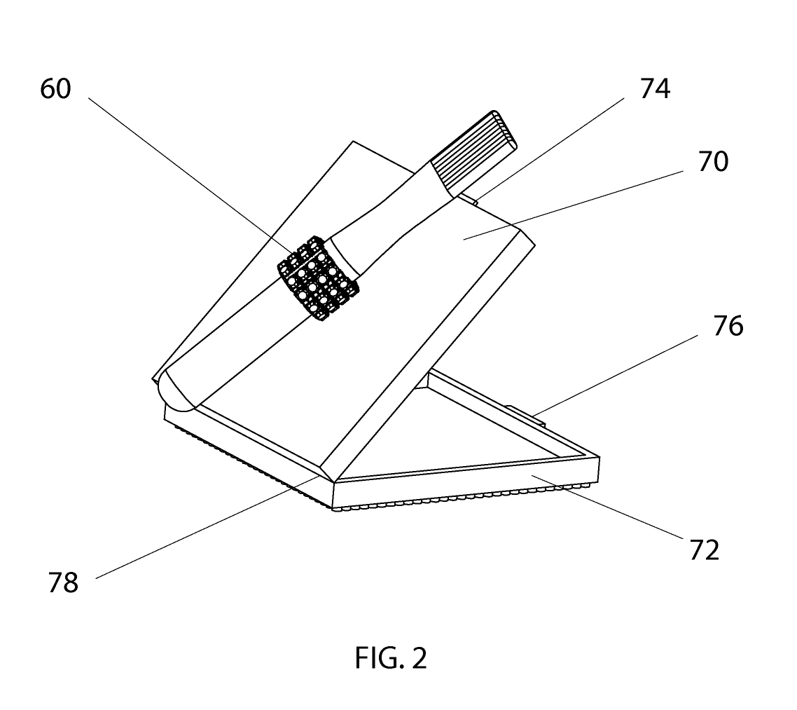

In one embodiment, as demonstrated in FIG. 2, a hard case has a First Hard Case Portion 70 and a Second Hard Case Portion 72 connected at a Hinge 78, and having a Locking Mechanism 74 and a Locking Mechanism Receiver 76.

In use, a ring 60 is placed about an individualized article and magnet 48 is placed in proximity to either First Main Body Rigid Support 24 or Second Main Body Rigid Support 22 in which magnetic material is contained therewith. The magnetic attraction attaches ring 60 into position and allows implements to be carried in a magnetized case configuration.

In one embodiment, ring 60 is placed about the perimeter of a makeup brush. The assembly holds one or more brushes in place and they are individually separable from the assembly. The incorporated magnets hold each brush in place and a user selects and removes a desired brush as desired.

While the invention has been described in its preferred form or embodiment with some degree of particularity, it is understood that this description has been given only by way of example and that numerous changes in the details of construction, fabrication and use, including the combination and arrangement of parts, may be made without departing from the spirit and scope of the invention.

What is claimed is:

1. A system for carrying individualized articles, said system comprising:
a main carrier having at least one magnetic material incorporated therewith;
at least one expandable ring, having a central cavity and a relaxed configuration and an expanded configuration,
whereby said expanded configuration is achieved by applying pressure to an expandable material incorporated with said expanded ring, said expanded ring further comprising at least one magnet constructed and arranged to interact with said magnet of said main body.

2. The system of claim 1 wherein the main carrier magnetic material is incorporated with either or both of a first main body rigid support or second main body rigid support.

3. The system of claim 1 wherein said main carrier is configured as a foldable case.

4. The system of claim 1 wherein said expanded ring is configured for placement about the perimeter of an individualized article.

5. The system of claim 4 wherein said individualized article is at least one of a makeup brush, pencil, pen, hand tool, stylus, artists tool, or combinations thereof.

6. The system of claim 1 wherein said main carrier carries at least one individualized article positioned within said ring central cavity and secured into position by said one magnet constructed and arranged to interact with said magnet of said main body.
